(19) United States
(12) Patent Application Publication
(10) Pub. No.: US 2026/0307583 A1
(43) Pub. Date: Oct. 8, 2026

(54) INFORMATION PROCESSING APPARATUS, INFORMATION PROCESSING METHOD, AND ROAD PROJECTION SYSTEM

(71) Applicant: SONY GROUP CORPORATION, Tokyo (JP)

(72) Inventors: Koji Nagata, Tokyo (JP); Ryuichi Suzuki, Tokyo (JP); Masa Miyao, Kanagawa (JP); Keita Mori, Kanagawa (JP); Keisuke Homma, Kanagawa (JP); Kotoko Yamaguchi, Kanagawa (JP)

(73) Assignee: SONY GROUP CORPORATION, Tokyo (JP)

(21) Appl. No.: 18/996,778

(22) PCT Filed: Jul. 21, 2023
(86) PCT No.: PCT/JP2023/026801

§ 371 Date: Jan. 17, 2025

(30) Foreign Application Priority Data
May 8, 2022 (JP) 2022-125307

(51) Int. Cl. B60Q 1/50

(52) U.S. Cl. CPC B60Q 1/547; B60Q 1/507; B60Q 1/543; B60Q 2400/50

(57) ABSTRACT

The present technology relates to an information processing apparatus, an information processing method, and a road projection system that establish more reliable communication with surrounding traffic participants.

According to a driving plan for a mobile body and road surface condition information indicating conditions of a road surface on which the mobile body is driving, a projection control section controls output of projection information that is projected from the mobile body onto the road surface to establish communication with others. The present technology is applicable, for example, to vehicles that perform road projection.

### TECHNICAL FIELD

The present technology relates to an information processing apparatus, an information processing method, and a road projection system, and more particularly, to an information processing apparatus, an information processing method, and a road projection system that establish more reliable communication with surrounding traffic participants.

### BACKGROUND ART

In recent years, many technologies have been proposed for establishing communication with surrounding traffic participants by projecting information from a mobile body onto a road surface on which the mobile body is driving.

There is disclosed, for example, in PTL 1, a vehicle lighting system that emits light outward to visually present information for prompting an oncoming vehicle to stop on the basis of a width of the oncoming vehicle and a width of a road ahead of a host vehicle.

### PATENT LITERATURE

### PTL 1

PCT Patent Publication No. WO2019/131329

### SUMMARY

### Technical Problem

However, in a case where the road surface is not in a suitable condition for projection, there is a risk that communication with surrounding traffic participants may be hindered.

The present technology has been made in view of the above circumstances. An object of the present technology is to establish more reliable communication with surrounding traffic participants.

### Solution to Problem

An information processing apparatus according to the present technology is an information processing apparatus including a projection control section that, according to a driving plan for a mobile body and road surface condition information indicating conditions of a road surface on which the mobile body is driving, controls output of projection information that is projected from the mobile body onto the road surface to establish communication with others.

An information processing method according to the present technology is an information processing method including, by an information processing apparatus, controlling, according to a driving plan for a mobile body and road surface condition information indicating conditions of a road surface on which the mobile body is driving, output of projection information that is projected from the mobile body onto the road surface to establish communication with others.

A road projection system according to the present technology is a road projection system including a projection control section that, according to a driving plan for a mobile body and road surface condition information indicating conditions of a road surface on which the mobile body is driving, controls output of projection information that is projected from the mobile body onto the road surface to establish communication with others, and a projection section that projects the projection information onto the road surface.

The present technology controls, according to a driving plan for a mobile body and with road surface condition information indicating conditions of a road surface on which the mobile body is driving, output of projection information that is projected from the mobile body onto the road surface to establish communication with others.

### BRIEF DESCRIPTION OF DRAWINGS

FIG. 1 is a block diagram illustrating an outline of a configuration of a mobile body according to the present technology.

FIG. 2 is a diagram illustrating an example of installation of a projection section and its projection range.

FIG. 3 is a flowchart illustrating an outline of an operation of the mobile body.

FIG. 4 is a diagram illustrating an example of projection information that is projected in such a manner as to avoid unsuitable regions.

FIG. 5 is a diagram illustrating an example of projection information that is projected in such a manner as to avoid unsuitable regions.

FIG. 6 is a diagram illustrating an example of projection information that is projected in such a manner as to avoid unsuitable regions.

FIG. 7 is a block diagram illustrating a specific example of the configuration of the mobile body.

FIG. 8 is a flowchart illustrating a flow of road projection processing performed by the mobile body.

FIG. 9 is a diagram illustrating an example of an optical system.

FIG. 10 is a block diagram illustrating an example of the configuration of a computer.

### DESCRIPTION OF EMBODIMENT

An embodiment for implementing the present technology (hereinafter referred to as the embodiment) will now be described in the following order.
1. Conventional Technologies and Their Problems
2. Overview of Configuration and Operation of Mobile Body according to Present Technology
3. Specific Example of Configuration of Mobile Body and
4. Example of Optical System
5. Example of Computer Configuration

### 1. Conventional Technologies and Their Problems

Conventionally, a welcome light (welcome lamp) is known as a road projection apparatus for a vehicle. The welcome light welcomes a vehicle occupant when a door of the vehicle opens or unlocks. Lighting by the welcome light is used for decorative purposes, and does not pose a big problem even in a case where a projection is not visually recognizable due, for instance, to road surface conditions unsuitable for projection.

Meanwhile, in recent years, many technologies have been proposed to establish communication with surrounding traffic participants by projecting information from a mobile body onto the road surface on which the mobile body is driving. In a case where a road projection is used for communication with other traffic participants, the projected information should be visually recognizable by the traffic participants whenever possible.

However, no technology has been proposed for adjusting the information to be projected in a case where the road surface conditions are not suitable for projection. Consequently, there has been a risk that the communication with surrounding traffic participants might be hindered.

Further, in order to project information onto the road surface, the projected light needs to scatter on the road surface. For example, in a case where information, such as a video, is projected onto the road surface that reflects light specularly, not only will the surrounding traffic participants be unable to visually recognize the video, but strong reflected light may directly strike the surrounding traffic participants, increasing the risk of traffic accidents.

In view of the above circumstances, the present technology establishes more reliable communication with the surrounding traffic participants by controlling, according to a driving plan for the mobile body and with the road surface conditions, the output of projection information to be projected onto the road surface.

### 2. Overview of Configuration and Operation of Mobile Body According to Present Technology>

### Configuration of Mobile Body

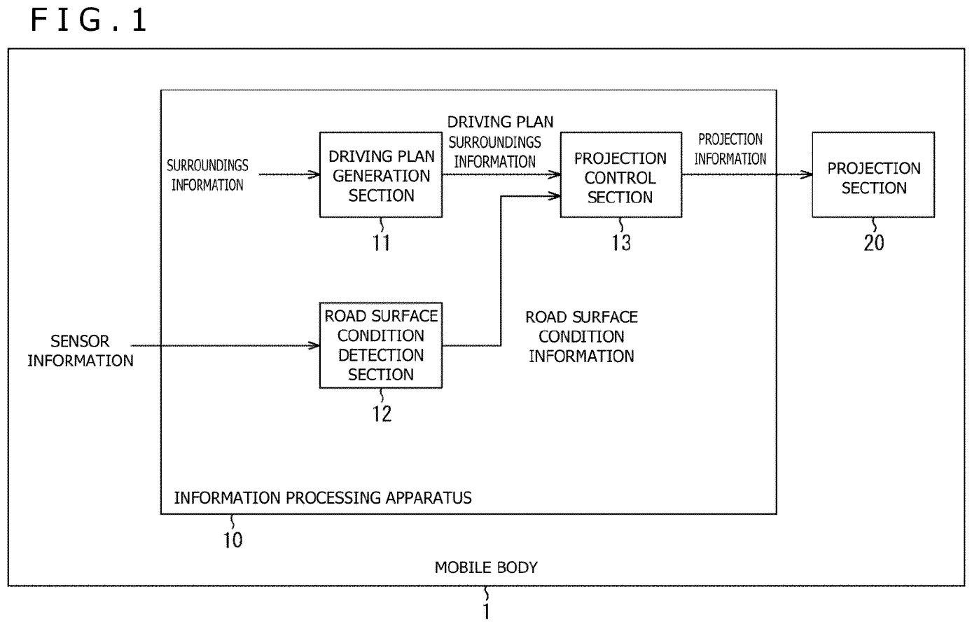

FIG. 1 is a block diagram illustrating an outline of a configuration of the mobile body according to the present mobile body 1 depicted in FIG. 1 is configured, for example, as an automated vehicle (automobile). Alternatively, however, the mobile body 1 may be configured as an autonomous mobile robot that moves in public spaces.

The mobile body 1 includes an information processing apparatus 10 and a projection section 20, and is capable of functioning as a road projection system that projects projection information, such as a video, onto the road surface on which the mobile body 1 is driving.

The information processing apparatus 10 includes, for example, an ECU (Electronic Control Unit), additional control units such as a dedicated processor, and a computer, which are mounted in the mobile body 1. Meanwhile, the projection section 20 includes, for example, a projection device such as a liquid crystal microdisplay.

Under the control of the information processing apparatus 10, the projection section 20 projects the projection information, such as a video, onto the road surface on which the mobile body 1 is driving. The projection information to be projected by the projection section 20 is presentation information for communication with others, and includes a display of the behavior of the mobile body 1 (host vehicle), an advance notification of the behavior of the host vehicle, a promotion of the behavior of others, and an alert to others.

The information processing apparatus 10 includes a driving plan generation section 11, a road surface condition detection section 12, and a projection control section 13.

The driving plan generation section 11 generates a driving plan, including, for example, a driving route and transit points over which the mobile body 1 drives, a driving speed at each passing point, and a destination, according to surroundings information regarding the surroundings of the mobile body 1, and supplies the generated driving plan and the surroundings information to the projection control section 13.

The surroundings information includes, for example, projection information (others-projected information) projected by others onto the road surface on which the mobile body 1 is driving, and traffic condition information indicating the traffic conditions around the mobile body 1. Here, the others include other traffic participants around the mobile body 1 (other vehicles and pedestrians) and, for example, smart poles installed in public spaces.

The surroundings information is acquired according to sensor information derived from various undepicted sensors disposed on the mobile body 1 and information derived from devices capable of communicating with the mobile body 1.

The road surface condition detection section 12 detects, on the basis of the sensor information described above, the conditions of the road surface on which the mobile body 1 is driving, and supplies road surface condition information, which indicates the detected road surface conditions, to the projection control section 13.

The road surface condition information includes unsuitable region information indicating the locations of unsuitable regions that are regions on the road surface on which the mobile body 1 drives and unsuitable for projection of the projection information. The unsuitable regions on the road surface include puddles or other light-reflecting surfaces, surface irregularities, and obstacles. For example, the road surface condition detection section 12 is able to detect specularly reflecting puddles as unsuitable regions according to a polarized video derived from a polarization camera disposed on the mobile body 1. In addition, the road surface condition detection section 12 is able to detect surface irregularities and obstacles on the road surface as unsuitable regions according to sensor information derived, for example, from a ToF (Time of Flight) sensor disposed on the mobile body 1.

The projection control section 13 controls the output of projection information according to the driving plan and surroundings information derived from the driving plan generation section 11 and the road surface condition information derived from the road surface condition detection section 12. Stated differently, the projection control section 13 controls the projection section 20 to project the projection information for communication with the others onto the road surface from the projection section 20. In this instance, the projection control section 13 controls the output of projection information in such a manner as to avoid projection onto the unsuitable regions according to the unsuitable region information included in the road surface condition information.

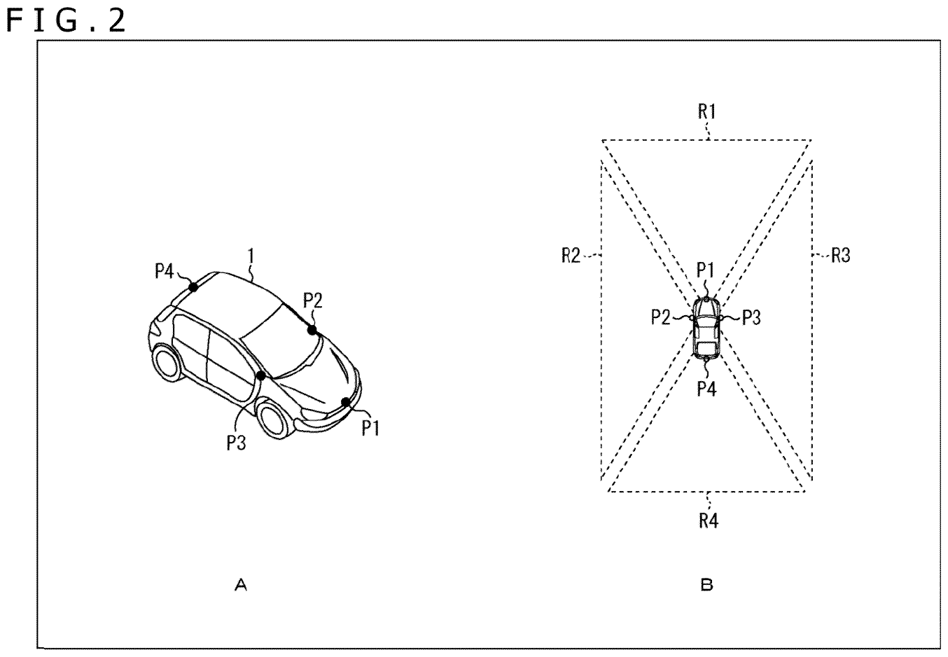

FIG. 2 is a diagram illustrating an example of installation of the projection section 20 and its projection range.

As depicted in part A of FIG. 2, projection devices P1 to P4, which act as the components of the projection section 20, are installed at the front end, the left side, the right side, and the rear of the mobile body 1, respectively.

Consequently, as depicted in part B of FIG. 2, the front region R1, the left region R2, the right region R3, and the rear region R4 of the mobile body 1 become the projection ranges of the projection devices P1 to R4, respectively. It should be noted that, in part B of FIG. 2, the front region R1, the left region R2, the right region R3, and the rear region R4 are depicted as having gaps between the adjacent projection ranges. In actual use, however, such regions R1 to R4 can be set so as to overlap with the adjacent projection ranges. In other words, the projection section 20 is able to project the projection information onto the entire circumference of the mobile body 1.

It should also be noted that, for example, the installation location and the imaging range of the polarization camera configured to capture a polarized video for detecting the road surface conditions are similar to the installation location and the projection range of the projection section 20.

### Operation of Mobile Body

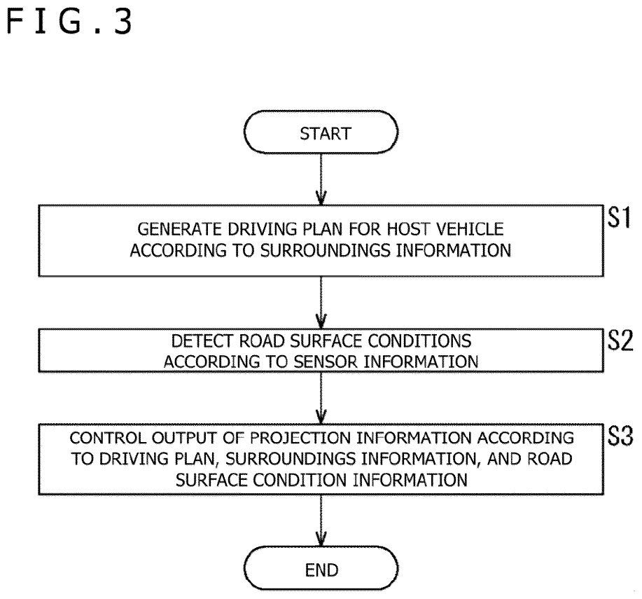

The operation of the mobile body 1 (information processing apparatus 10) will now be outlined with reference to the flowchart of FIG. 3.

In step S1, the driving plan generation section 11 generates the driving plan for the mobile body 1 (host vehicle) according to the surroundings information regarding the surroundings of the mobile body 1.

In step S2, the road surface condition detection section 12 detects, on the basis of the sensor information, the conditions of the road surface on which the mobile body 1 is driving.

In step S3, the projection control section 13 controls the output of the projection information according to the driving plan generated by the driving plan generation section 11, the surroundings information, and the road surface condition information indicating the road surface conditions detected by the road surface condition detection section 12. Specifically, the projection control section 13 controls the output of the projection information in such a manner as to avoid projection onto the unsuitable regions according to the unsuitable region information included in the road surface condition information.

### Example of Projection Information Projected so as to Avoid Unsuitable Regions

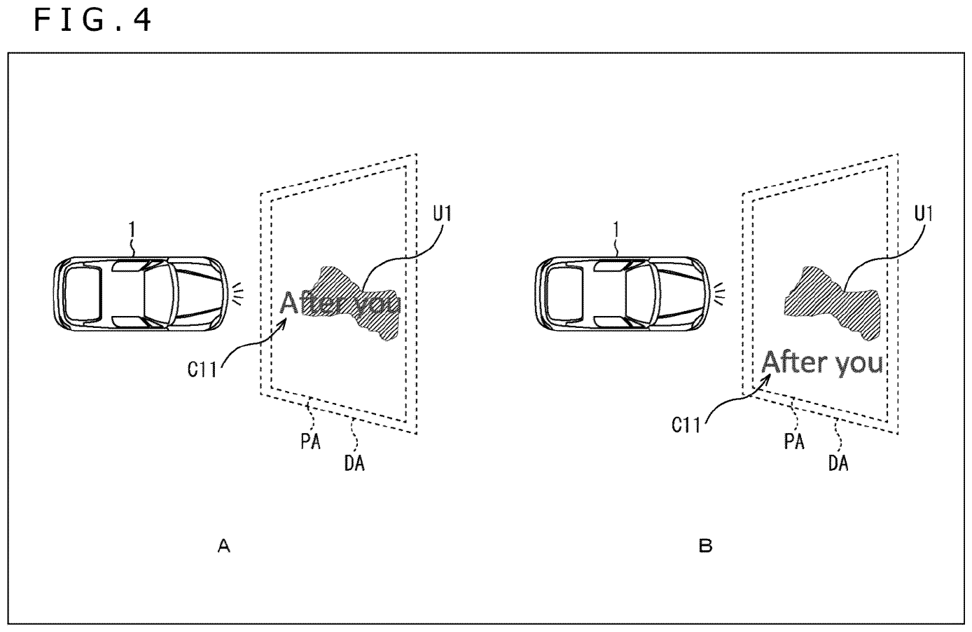

An example of the projection information projected in such a manner as to avoid projection onto unsuitable regions will now be described with reference to FIGS. 4 to 6.

FIG. 4 is a diagram illustrating a first example of the projection information that is projected in such a manner as to avoid projection onto unsuitable regions.

In the example of FIG. 4, projection information C11 including the character string “After you,” which is a message to pedestrians, is projected from the mobile body 1 onto the road surface ahead of the mobile body 1. The projection information C11 can be projected within a projection range PA of the projection section 20. An unsuitable region detection range DA, where unsuitable regions can be detected by various sensors disposed on the mobile body 1, is set so as to include the projection range PA.

As depicted in part A of FIG. 4, in a case where a specularly reflecting puddle Ul is detected as an unsuitable region at a projection location of the projection information C11, there is a possibility that the projection light of the projection information C11 will be reflected and visually unrecognizable by pedestrians. Therefore, it is desirable that the projection light of the projection information C11 be projected onto the road surface on which the projection light scatters.

In a case where the intention of the message, such as a message to pedestrians, would not be lost even after a projection location change, road projection can be performed after changing the projection location of the projection information C11 so as to avoid the puddle U1 within the projection range PA as depicted in part B of FIG. 4.

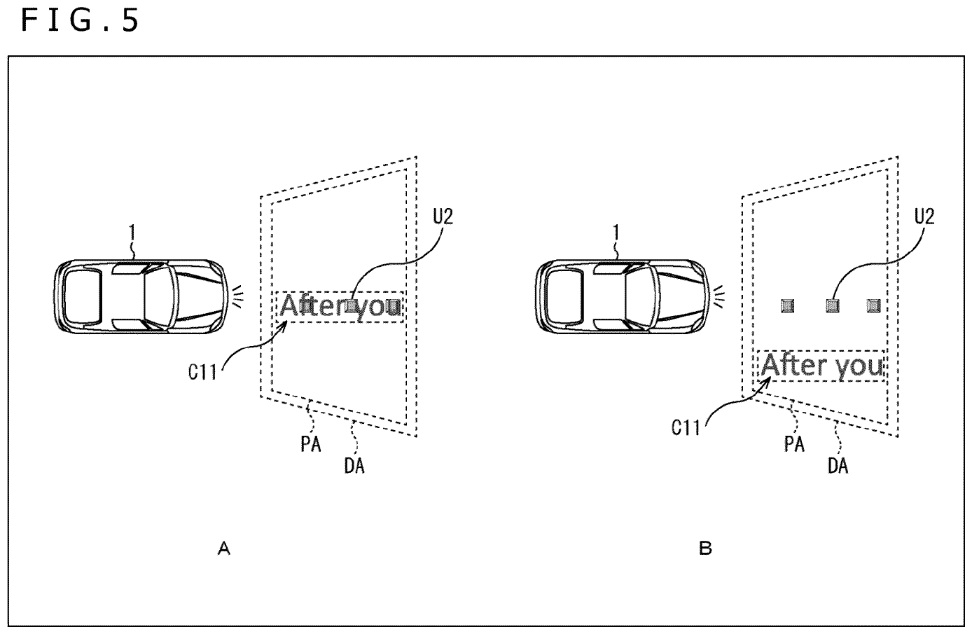

FIG. 5 is a diagram illustrating a second example of the projection information that is projected in such a manner as to avoid projection onto unsuitable regions.

The example of FIG. 5 also depicts a situation where the projection information C11 including the character string “After you,” which is a message to pedestrians, is projected from the mobile body 1 onto the road surface ahead of the mobile body 1.

In a case where a cat's eye U2 is detected as an obstacle at the projection location of the projection information C11 and regarded as an unsuitable region as depicted in part A of FIG. 5, the projection light of the projection information C11 may be distorted and visually unrecognizable by pedestrians. Therefore, it is desirable that the projection light of the projection information C11 be projected onto a flat road surface without obstacles.

If the intention would not be lost even after a projection location change, such as in the case of a message to pedestrians, which is depicted in the example of FIG. 4, the projection location of the projection information C11 can be changed and projected onto the road surface in such a manner as to avoid the cat's eye U2 within the projection range PA, as depicted in part B of FIG. 5.

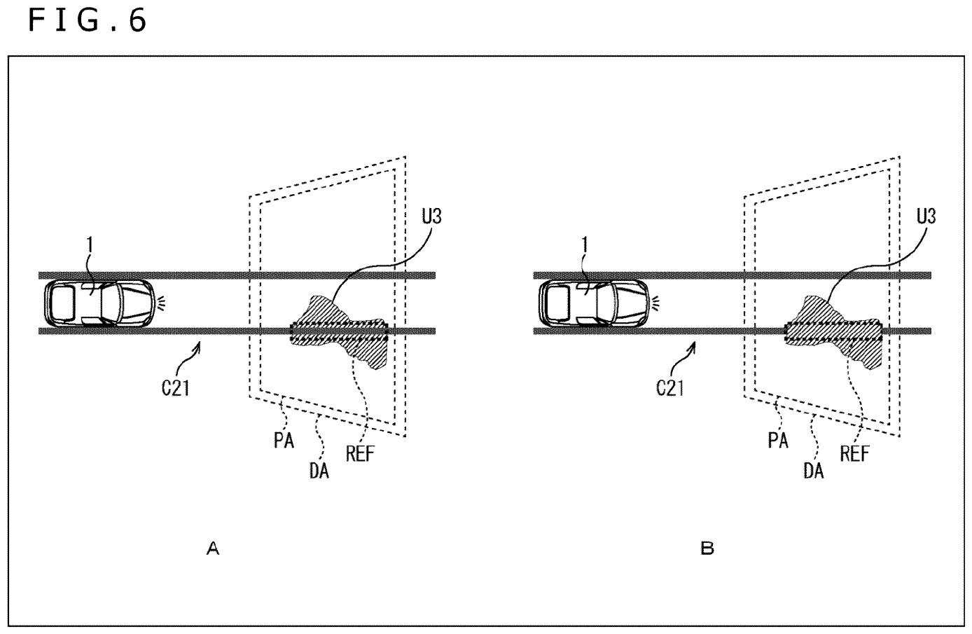

FIG. 6 is a diagram illustrating a third example of the projection information that is projected in such a manner as to avoid projection onto unsuitable regions.

In the example of FIG. 6, projection information C21 indicating a future driving path, which is an indication of the behavior of the mobile body 1, is projected from the mobile body 1 onto the road surface ahead of the mobile body 1.

In a case where a specularly reflecting puddle U3 is detected as an unsuitable region at the projection location of the projection information C21 as depicted in part A of FIG. 6, there is a possibility that the projection light of the projection information C21 in the range REF corresponding to the puddle U3 will be reflected and visually unrecognizable by surrounding traffic participants. However, if the projection location of the projection information C21 is changed in this case, the result of such a change may differ from or otherwise deviate from the original intention.

In a case where changing the projection location would impair the intention, such as in the case of a driving path, road projection can be performed, as depicted in part B of FIG. 6, by deleting a portion of the projection light of the projection information C21 that is within the range REF corresponding to the puddle U3.

Performing the above-described processing makes it possible to output the projection information that avoids projection onto unsuitable regions according to the driving plan for the mobile body and the conditions of the road surface. This enables the surrounding traffic participants to visually recognize the projection information projected onto the road surface with increased accuracy, and makes it possible to communicate more reliably with the surrounding traffic participants.

Particularly, since it is possible to prevent the projection information from being projected onto puddles or other specularly reflecting objects, the surrounding traffic participants are able to visually recognize the projection information, and it is also possible to prevent strong reflected light from directly shining on the surrounding traffic participants, thereby reducing the risk of traffic accidents.

### 3. Specific Example of Configuration of Mobile Body and Road Projection Processing

The following describes a specific example of the configuration of the mobile body 1 described above and the flow of road projection processing performed by the mobile body 1.

### Specific Example of Configuration of Mobile Body

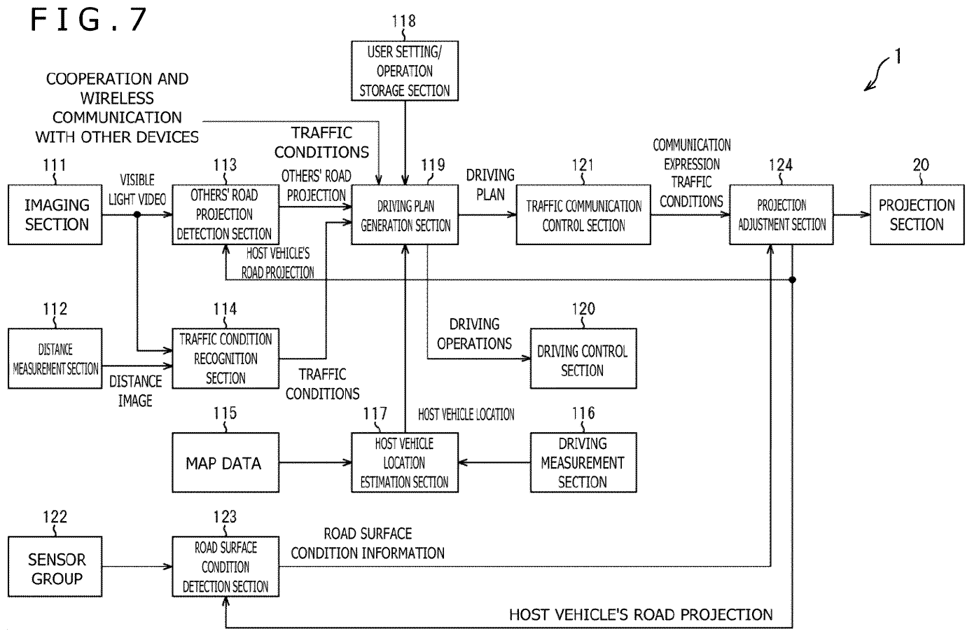

FIG. 7 is a block diagram illustrating a specific example of the configuration of the mobile body 1.

The mobile body 1 depicted in FIG. 7 includes an imaging section 111, a distance measurement section 112, an others' road projection detection section 113, a traffic condition recognition section 114, map data 115, a driving measurement section 116, a host vehicle location estimation section 117, a user setting/operation storage section 118, a driving plan generation section 119, and a driving control section 120.

The imaging section 111 includes a visible light camera that captures an image of the surroundings of the mobile body 1. The imaging section 111 supplies a visible light video, which is acquired by capturing the image of the surroundings of the mobile body 1, to the others' road projection detection section 113 and the traffic condition recognition section 114.

The distance measurement section 112 includes a sensor capable of measuring distance, such as a ToF sensor or a LiDAR (Light Detection and Ranging) sensor. The distance measurement section 112 acquires a distance image indicating the distance in the depth direction, and supplies the acquired distance image to the traffic condition recognition section 114.

The others' road projection detection section 113 detects others-projected information according to the distance image supplied from the distance measurement section 112. The others' projection information (hereinafter also referred to, for example, as the others' road projection) is information projected onto the road surface by the others (e.g., other vehicles, pedestrians, and smart poles). The detected others' projection information is supplied to the driving plan generation section 119.

The traffic condition recognition section 114 recognizes the traffic conditions around the mobile body 1 (e.g., the attributes and locations of the others, the direction of movement, and the speed of movement) according to the visible light video supplied from the imaging section 111 and the distance image supplied from the distance measurement section 112. Traffic condition information indicating the recognized traffic conditions around the mobile body 1 is supplied to the driving plan generation section 119.

The map data 115 is map data regarding an area where the mobile body 1 drives.

The driving measurement section 116 measures driving data related to the driving of the mobile body 1 (host vehicle), such as driving locations, driving speeds, and driving operations including accelerations/decelerations and steering operations, and supplies the measured driving data to the host vehicle location estimation section 117.

The host vehicle location estimation section 117 estimates the location of the mobile body 1 (host vehicle) in the map data 115 according to the driving data from the driving measurement section 116. Host vehicle location information indicating the estimated location of the host vehicle is supplied to the driving plan generation section 119.

The user setting/operation storage section 118 stores setting information and operation information related to driving by the user (driver) of the mobile body 1. The setting information and the operation information include, for example, mode information indicating an automated driving mode of the mobile body 1. The setting information and the operation information stored in the user setting/operation storage section 118 are read out as needed to the driving plan generation section 119.

The driving plan generation section 119 corresponds to the driving plan generation section 11 depicted in FIG. 1. The driving plan generation section 119 generates a driving plan for the mobile body 1 (host vehicle) according to the others-projected information from the others' road projection detection section 113 and the traffic condition information from the traffic condition recognition section 114, which are used as the surroundings information, and the host vehicle location information from the host vehicle location estimation section 117.

Further, the driving plan generation section 119 may generate the driving plan for the mobile body 1 by using the traffic condition information that is obtained by mutual cooperation and wireless communication with other devices such as on-board equipment mounted in the other vehicles, information terminals carried by pedestrians, and smart poles and other ITS (Intelligent Transport Systems) equipment. The driving plan generation section 119 supplies driving operation information according to the generated driving plan to the driving control section 120.

The driving control section 120 controls the automated driving of the mobile body 1 according to the driving operation information derived from the driving plan generation section 119.

The mobile body 1 further includes a traffic communication control section 121, a sensor group 122, a road surface condition detection section 123, and a projection adjustment section 124.

The traffic communication control section 121 acquires the driving plan generated by the driving plan generation section 119 and the surroundings information used for such driving plan generation. The traffic communication control section 121 functions as a projection information generation section, and generates a communication expression relative to others as the projection information according to the acquired driving plan.

The communication expression includes projection location information indicating the projection location thereof and location changeability information indicating whether or not the projection location is changeable. In a case where the projection location of the communication expression is a requirement for the relevant communication, that is, in a case where the intention of the communication expression would be impaired due to a change in the projection location of the communication expression, the location changeability information is generated to indicate that the projection location cannot be changed.

The traffic communication control section 121 supplies the generated communication expression and the traffic condition information, which is included in the surroundings information from the driving plan generation section 119, to the projection adjustment section 124.

The sensor group 122 includes, for example, a polarization camera and a ToF sensor, and senses the road surface on which the mobile body 1 is driving. The sensor information acquired by allowing the sensor group 122 to sense the road surface is supplied to the road surface condition detection section 123.

The road surface condition detection section 123 corresponds to the road surface condition detection section 12 depicted in FIG. 1. The road surface condition detection section 123 detects, on the basis of the sensor information from the sensor group 122, the conditions of the road surface on which the mobile body 1 is driving. Specifically, the road surface condition detection section 123, which detects the conditions of the road surface on which the mobile body 1 is driving, functions as an unsuitable region detection section that detects a region unsuitable for projecting the projection information onto the road surface on which the mobile body 1 is driving. The road surface condition information including the unsuitable region information indicating the location of the unsuitable region is supplied to the projection adjustment section 124.

The projection adjustment section 124, together with the traffic communication control section 121, corresponds to the projection control section 13 depicted in FIG. 1.

The projection adjustment section 124 controls the projection section 20 according to the communication expression and the traffic information derived from the traffic communication control section 121, thereby projecting the communication expression onto the road surface from the projection section 20. In this instance, the projection adjustment section 124 adjusts the communication expression, which is projected onto the road surface, according to the unsuitable region information included in the road surface condition information derived from the road surface condition detection section 123, thereby controlling the projection of the communication expression so as to avoid the unsuitable region.

The communication expression (the host vehicle's road projection) obtained upon projection adjustment in the above-described manner is fed back to the others' road projection detection section 113. This enables the others' road projection detection section 113 to detect the others' road projection, which is projected onto the road surface, while distinguishing the others' road projection from the host vehicle's road projection.

Further, the communication expression (the host vehicle's road projection) obtained upon projection adjustment is also fed back to the road surface condition detection section 123. This enables the road surface condition detection section 123 to detect unsuitable regions while excluding the host vehicle's road projection from detection targets.

Furthermore, although not depicted, the communication expression (the host vehicle's road projection) obtained upon projection adjustment may be fed back to the driving control section 120. In this case, the driving control section 120 is able to modify the driving control of the mobile body 1 (host vehicle) according to the host vehicle's road projection.

### Road Projection Processing by Mobile Body

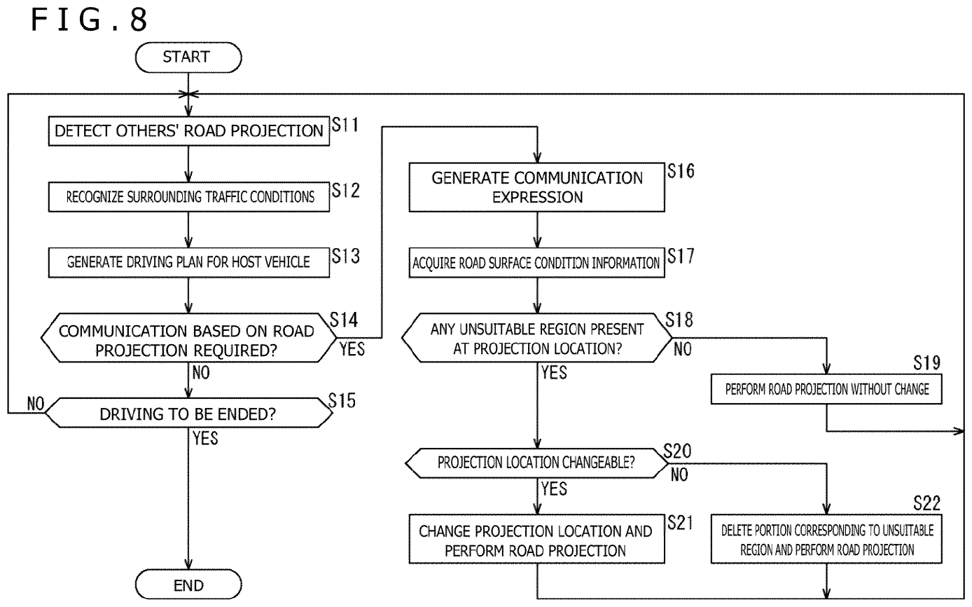

The flow of road projection processing performed by the mobile body 1 in FIG. 7 will now be described with reference to the flowchart of FIG. 8. The processing depicted in FIG. 8 can be performed, for example, while the mobile body 1 is driving.

In step S11, the others' road projection detection section 113 detects the others' road projection according to the distance image acquired by the distance measurement section 112.

In step S12, the traffic condition recognition section 114 recognizes the traffic conditions around the mobile body 1 according to the visible light video captured by the imaging section 111 and the distance image acquired by the distance measurement section 112.

In step S13, the driving plan generation section 119 generates the driving plan for the mobile body 1 (host vehicle) according to the others' road projection, the surrounding traffic conditions, and the location of the host vehicle, which are used as the surroundings information.

In step S14, according to the driving plan generated by the driving plan generation section 119 and the others' road projection and surrounding traffic conditions used for generating the driving plan, the traffic communication control section 121 determines whether or not communication provided by road projection is necessary.

In a case where it is determined in step S14 that communication provided by road projection is not necessary, the processing proceeds to step S15. In step S15, the driving control section 120 determines, on the basis of the driving plan generated by the driving plan generation section 119, whether or not to end driving.

In a case where it is determined in step S15 that the driving is not to be ended, the processing returns to step S11, and then repeats steps S11 and subsequent steps.

Meanwhile, in a case where it is determined in step S15 that the driving is to be ended, the mobile body 1 ends the driving, and then the processing terminates.

Incidentally, in a case where it is determined in step S14 that communication provided by road projection is necessary, the processing proceeds to step S16.

In step S16, the traffic communication control section 121 generates a necessary communication expression according to the driving plan generated by the driving plan generation section 119.

In step S17, the projection adjustment section 124 acquires the road surface condition information from the road surface condition detection section 123.

In step S18, on the basis of the projection location information included in the communication expression and the unsuitable region information included in the road surface condition information, the projection adjustment section 124 determines whether or not an unsuitable region is present at the projection location of the communication expression.

In a case where it is determined in step S18 that no unsuitable region is present at the projection location of the communication expression, the processing proceeds to step S19.

In step S19, the projection adjustment section 124 controls the projection section 20 to project the communication expression onto the road surface without change. Subsequently, the processing returns to step S11, and then repeats steps S11 and subsequent steps.

Meanwhile, in a case where it is determined in step S18 that an unsuitable region is present at the projection location of the communication expression, the processing proceeds to step S20.

In step S20, the projection adjustment section 124 determines, on the basis of the location changeability information included in the communication expression, whether or not the projection location of the communication expression is changeable.

In a case where it is determined in step S20 that the projection location of the communication expression is changeable, that is, in a case where the intention of the communication expression would not be impaired even though the projection location of the communication expression is changed, the processing proceeds to step S21.

In step S21, the projection adjustment section 124 changes the projection location information included in the communication expression, thereby performing road projection (projecting the communication expression) by changing a projection location in a manner described with reference to FIGS. 4 and 5. Thereafter, the processing returns to step S11, and then repeats steps S11 and subsequent steps.

Meanwhile, in a case where it is determined in step S20 that the projection location of the communication expression cannot be changed, that is, in a case where the intention of the communication expression would be impaired due to a change in the projection location of the communication expression, the processing proceeds to step S22.

In step S22, the projection adjustment section 124 deletes a portion corresponding to the unsuitable region and performs road projection (projects the communication expression) in a manner described with reference to FIG. 6. Thereafter, the processing returns to step S11, and then repeats steps S11 and subsequent steps.

When the above processing is performed, the communication expression is projected according to the driving plan for the mobile body and the conditions of the road surface while avoiding unsuitable regions. This enables the surrounding traffic participants to visually recognize the communication expression projected onto the road surface with increased accuracy, and makes it possible to communicate more reliably with the surrounding traffic participants.

Particularly, since it is possible to prevent the communication expression from being projected onto puddles or other specularly reflecting objects, the surrounding traffic participants are able to visually recognize the communication expression, and it is also possible to prevent strong reflected light from directly shining on the surrounding traffic participants, thereby reducing the risk of traffic accidents.

### 4. Example of Optical System

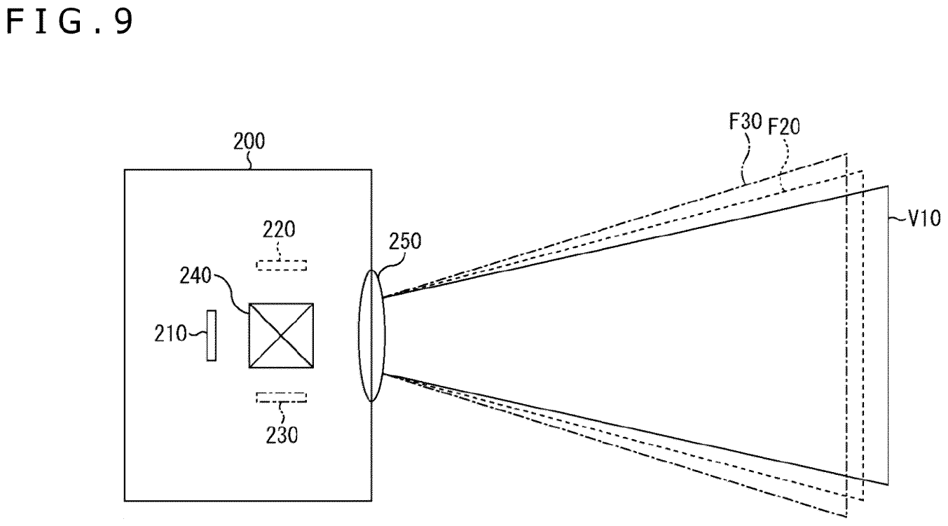

FIG. 9 is a diagram illustrating an example of an optical system that can be mounted in the mobile body 1 according to the present technology.

A projection apparatus 200 depicted in FIG. 9 includes a projection device 210, a visible light image sensor 220, a polarization image sensor 230, a beam splitter 240, and a lens 250.

The projection device 210 corresponds to the projection section 20 included in the mobile body 1, and projects the projection information, through the lens 250, onto the road surface on which the mobile body 1 is driving.

The visible light image sensor 220 corresponds to the imaging section 111 included in the mobile body 1, and acquires a visible light video by capturing an image of the surroundings of the mobile body 1.

The polarization image sensor 230 corresponds to polarization cameras belonging to the sensor group 122 included in the mobile body 1, and acquires a polarized video by capturing an image of the road surface on which

The beam splitter 240 splits the light incident on the lens 250 into at least two, which are then incident on the visible light image sensor 220 and the polarization image sensor 230.

In the projection apparatus 200, the single lens 250 is shared by all of the angle of view V10 of the projection device 210, the viewing frustum F20 of the visible light image sensor 220, and the viewing frustum F30 of the polarization image sensor 230. Accordingly, the present technology allows one lens to be shared by the angle of view of the projection device, which projects the projection information, and by at least one of the viewing frustums of the visible light camera and polarization camera.

### 5. Example of Computer Configuration

The above-described series of processes can be performed by hardware or by software. In a case where the series of processes is performed by software, a program included in the software is installed from a program recording medium into a computer incorporated in dedicated hardware or a general-purpose personal computer.

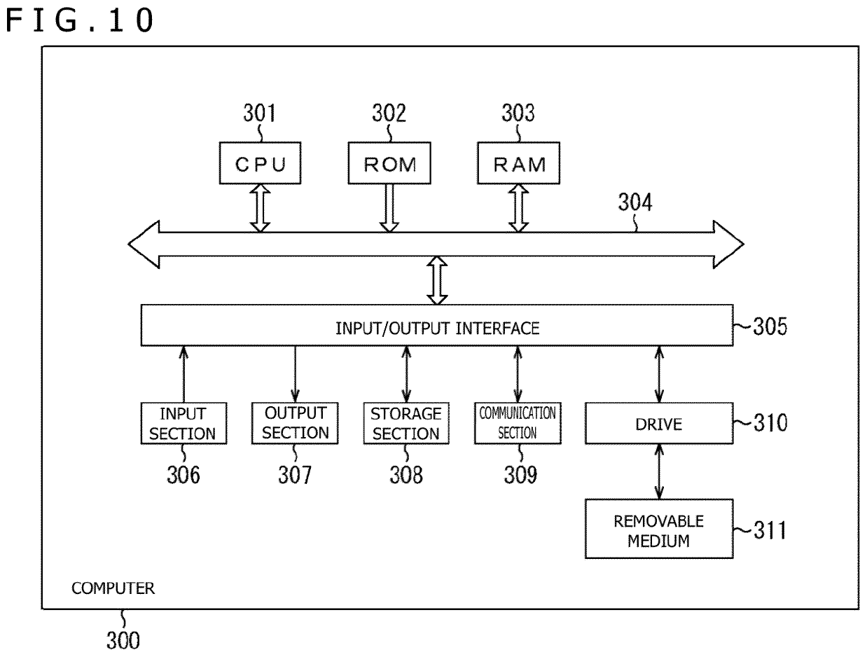

FIG. 10 is a block diagram illustrating an example of a configuration of hardware of a computer that performs the above-described series of processes by executing a program.

The above-described information processing apparatus 10 (mobile body 1) is implemented by a computer 300 having the configuration depicted in FIG. 10.

A CPU 301, a ROM 302, and a RAM 303 are interconnected by a bus 304.

The bus 304 is further connected to an input/output interface 305. The input/output interface 305 is connected to an input section 306 including, for example, a keyboard and a mouse, and to an output section 307 including, for example, a display and a speaker. Further, the input/output interface 305 is connected to a storage section 308 including, for example, a hard disk and a non-volatile memory, to a communication section 309 including, for example, a network interface, and to a drive 310 for driving a removable medium 311.

In the computer 300 configured as described above, the CPU 301 performs the above-described series of processes, for example, by loading a program stored in the storage section 308 into the RAM 303 through the input/output interface 305 and the bus 304, and executing the loaded program.

The program to be executed by the CPU 301 is recorded, for example, on a removable medium 311 or supplied through a wired or wireless transmission medium such as a local area network, the Internet, or a digital broadcasting system, and installed in the storage section 308.

It should be noted that the program to be executed by the computer 300 may perform processing in a chronological order described in this document or perform processing in a parallel manner or at a required timing in response, for example, to a program call.

Herein, “system” means an aggregation of multiple components (apparatuses, modules (parts), or the like), and it does not matter whether all the components are in the same housing or not. Hence, multiple apparatuses that are accommodated in separate housings and connected to each other via a network and a single apparatus including multiple modules accommodated in a single housing are both “system.”

The embodiment of the present technology is not limited to those described above. Various changes can be made without departing from the spirit and scope of the present technology.

Further, the advantages described in this document are merely illustrative and not restrictive. The present technology can additionally provide advantages other than those described in this document.

Additionally, the present technology may adopt the following configurations.
(1)

An information processing apparatus including:
a projection control section that, according to a driving plan for a mobile body and road surface condition information indicating conditions of a road surface on which the mobile body is driving, controls output of projection information that is projected from the mobile body onto the road surface to establish communication with others.
(2)

The information processing apparatus according to (1),
in which the road surface condition information includes unsuitable region information that indicates a location of an unsuitable region that is not suitable for projecting the projection information onto the road surface, and,
according to the unsuitable region information, the projection control section controls the output of the projection information in such a manner as to avoid projection onto the unsuitable region.
(3)

The information processing apparatus according to (2),
in which the unsuitable region includes a light-reflecting surface.
(4)

The information processing apparatus according to (2),
in which the unsuitable region includes a surface irregularity or an obstacle.
(5)

The information processing apparatus according to any one of (2) to (4),
in which the projection control section includes
   a projection information generation section that generates the projection information according to the driving plan, and
   a projection adjustment section that, according to the unsuitable region information, adjusts the projection information to be projected onto the road
(6)

The information processing apparatus according to (5),
in which the projection information includes projection location information that indicates a projection location of the projection information on the road surface, and
the projection adjustment section changes the projection location information in a case where the unsuitable region is present at the projection location of the projection information.
(7)

The information processing apparatus according to (6),
in which the projection information further includes location changeability information that indicates whether the projection location is changeable, and
the projection adjustment section changes the projection location information in a case where the location changeability information indicates that the projection location is changeable.
(8)

The information processing apparatus according to (7),
in which, in a case where the location changeability information indicates that the projection location is unchangeable, the projection adjustment section deletes a portion of the projection information that corresponds to the unsuitable region.
(9)

The information processing apparatus according to (8),
in which, in a case where the projection location of the projection information is a requirement for the communication, the projection information generation section generates the location changeability information that indicates that the projection location is unchangeable.
(10)

The information processing apparatus according to any one of (5) to (9), further including:
an unsuitable region detection section that detects the unsuitable region on the road surface,
in which the unsuitable region detection section excludes the projection information projected onto the road surface from targets for detection of the unsuitable region.
(11)

The information processing apparatus according to any one of (2) to (9),
in which, according to the driving plan and surroundings information regarding surroundings of the mobile body, the projection control section controls the output of the projection information in such a manner as to avoid projection onto the unsuitable region.
(12)

The information processing apparatus according to (11),
in which the surroundings information includes the projection information that is projected onto the road surface by the others.
(13)

The information processing apparatus according to (11),
in which the surroundings information includes traffic condition information indicating the traffic conditions around the mobile body.
(14)

The information processing apparatus according to any one of (1) to (13),
in which the others include other traffic participants around the mobile body.
(15)

An information processing method including:
by an information processing apparatus, controlling, according to a driving plan for a mobile body and road surface condition information indicating conditions of a road surface on which the mobile body is driving, output of projection information that is projected from the mobile body onto the road surface to establish communication with others.
(16)

A road projection system including:
a projection control section that, according to a driving plan for a mobile body and road surface condition information indicating conditions of a road surface on which the mobile body is driving, controls output of projection information that is projected from the mobile body onto the road surface to establish communication with others; and
a projection section that projects the projection information onto the road surface.
(17)

A program causing a computer to implement a process of:
controlling, according to a driving plan for a mobile body and road surface condition information indicating conditions of a road surface on which the mobile body is driving, output of projection information that is projected from the mobile body onto the road surface to establish communication with others.

### REFERENCE SIGNS LIST

1: Mobile body
10: Information processing apparatus
11: Driving plan generation section
12: Road surface condition detection section
13: Projection control section
111: Imaging section
112: Distance measurement section
113: Others' road projection detection section
114: Traffic condition recognition section
115: Map data
116: Driving measurement section
117: Host vehicle location estimation section
118: User setting/operation storage section
119: Driving plan generation section
120: Driving control section
121: Traffic communication control section
122: Sensor group
123: Road surface condition detection section
124: Projection adjustment section

1. An information processing apparatus comprising:
a projection control section that, according to a driving plan for a mobile body and road surface condition information indicating conditions of a road surface on which the mobile body is driving, controls output of projection information that is projected from the mobile body onto the road surface to establish communication with others.

2. The information processing apparatus according to claim 1,
wherein the road surface condition information includes unsuitable region information that indicates a location of an unsuitable region that is not suitable for projecting the projection information onto the road surface, and,
according to the unsuitable region information, the projection control section controls the output of the projection information in such a manner as to avoid projection onto the unsuitable region.

3. The information processing apparatus according to claim 2,
wherein the unsuitable region includes a light-reflecting surface.

4. The information processing apparatus according to claim 2,
wherein the unsuitable region includes a surface irregularity or an obstacle.

5. The information processing apparatus according to claim 2,
wherein the projection control section includes
a projection information generation section that generates the projection information according to the driving plan, and
a projection adjustment section that, according to the unsuitable region information, adjusts the projection information to be projected onto the road surface.

6. The information processing apparatus according to claim 5,
wherein the projection information includes projection location information that indicates a projection location of the projection information on the road surface, and
the projection adjustment section changes the projection location information in a case where the unsuitable region is present at the projection location of the projection information.

7. The information processing apparatus according to claim 6,
wherein the projection information further includes location changeability information that indicates whether the projection location is changeable, and
the projection adjustment section changes the projection location information in a case where the location changeability information indicates that the projection location is changeable.

8. The information processing apparatus according to claim 7,
wherein, in a case where the location changeability information indicates that the projection location is unchangeable, the projection adjustment section deletes a portion of the projection information that corresponds to the unsuitable region.

9. The information processing apparatus according to claim 8,
wherein, in a case where the projection location of the projection information is a requirement for the communication, the projection information generation section generates the location changeability information that indicates that the projection location is unchangeable.

10. The information processing apparatus according to claim 5, further comprising:
an unsuitable region detection section that detects the unsuitable region on the road surface,
wherein the unsuitable region detection section excludes the projection information projected onto the road surface from targets for detection of the unsuitable region.

11. The information processing apparatus according to claim 2,
wherein, according to the driving plan and surroundings information regarding surroundings of the mobile body, the projection control section controls the output of the projection information in such a manner as to avoid projection onto the unsuitable region.

12. The information processing apparatus according to claim 11,
wherein the surroundings information includes the projection information that is projected onto the road

13. The information processing apparatus according to claim 11,
wherein the surroundings information includes traffic condition information indicating the traffic conditions around the mobile body.

14. The information processing apparatus according to claim 1,
wherein the others include other traffic participants around the mobile body.

15. An information processing method comprising:
by an information processing apparatus, controlling,
according to a driving plan for a mobile body and road surface condition information indicating conditions of a road surface on which the mobile body is driving, output of projection information that is projected from the mobile body onto the road surface to establish communication with others.

16. A road projection system comprising:
a projection control section that, according to a driving plan for a mobile body and road surface condition information indicating conditions of a road surface on which the mobile body is driving, controls output of projection information that is projected from the mobile body onto the road surface to establish communication with others; and
a projection section that projects the projection information onto the road surface.
